(19) United States
(12) Patent Application Publication
(10) Pub. No.: US 2023/0220956 A1
(43) Pub. Date: Jul. 13, 2023

(54) Grilling device having a gas connection

(71) Applicant: WWS Metallformen GmbH, Hatzenbühl (DE)

(72) Inventor: Nicky Röper, Haßloch (DE)

(21) Appl. No.: 18/151,871

(22) Filed: Jan. 9, 2023

(30) Foreign Application Priority Data
Jan. 11, 2022 (EP) 22150873.2

(51) Int. Cl. F17C 13/08; A47J 37/07

(52) U.S. Cl. CPC F17C 13/084; A47J 37/0713; F17C 2201/056; F17C 2205/0153

(57) ABSTRACT

A grilling device and method for operating a grilling device. The grilling device comprises a grill housing, a gas-operated heating element, and a connecting element which can be connected to a fuel container. The gas-operated heating element is connected to the connecting element by means of a connecting conduit, wherein the connecting conduit has a fuel withdrawal portion adapted to carry fuel in a liquid form and an expansion portion adapted to carry the fuel in a gaseous state. The fuel withdrawal portion is connected to the connecting element upstream in the flow direction of the fuel and opens into the expansion portion downstream in the flow direction.

The present invention relates to a grilling device, in particular to a gas grilling device, according to the preamble of claim 1.

Outdoor food preparation, in particular outdoor grilling, is becoming increasingly popular. Up to now, charcoal grills have primarily been used to prepare food outdoors. A charcoal grill has the advantage of being flexible and easy to use, so that with the help of a charcoal grill it is possible to prepare food even in open terrain without or with hardly any infrastructure. Charcoal grills, however, have the disadvantage of being operated with an open fire and of producing a strong smell and smoke nuisance due to the combustion of charcoal. The use of charcoal grills is therefore not desirable everywhere. It is therefore prohibited to use charcoal grills in some regions, such as narrow inner-city regions or in very dry, fire-prone regions.

In particular in inner-city regions, where charcoal grills are not allowed due to the smoke they produce, gas grills have been used for a long time. However, these gas grills are often stand-alone units that are connected to a large gas cylinder or even to a gas conduit from a home supply. These gas grills are unsuitable for mobile use on the go, in particular in camping applications, as they are very difficult to transport due to the very heavy gas cylinders, among other things.

Gas grills have now been developed for camping applications, which grills are supplied by means of a small gas cylinder or gas cartridge. Since these gas cylinders or gas cartridges are comparatively small and light, they can be easily transported and are therefore very suitable for use in camping applications.

The mobile gas grills known so far, which are used in camping applications, commonly use gas cartridges, in which the fuel in the gas cartridge is in liquid form. This is achieved by keeping fuels such as liquefied gases in the gas cartridge at a pressure higher than the ambient pressure. The pressure required in the gas cylinder to liquefy the fuel depends, among other things, on the type of fuel selected. However, the fuel or heating elements commonly used in gas grills require a fuel in a gaseous state, or more specifically, an air-gas mixture. Therefore, gas cartridges having liquefied gases are usually not completely filled, so that there is enough space in a gas cartridge for the liquid fuel to expand and thus become at least partially gaseous. A gas cartridge or gas cylinder therefore usually contains both liquid and gaseous fuel, with the liquid fuel being at the bottom of the container. Above the liquid level, the fuel is in gaseous form.

Since the fuel for the gas grill must be provided in gaseous form, the fuel or gas connection is located at the top of the container so that the gaseous fuel in the gas cartridge above the liquid level can be easily withdrawn.

If larger quantities of gaseous fuel are required than are already present in the gas cartridge, the liquid fuel contained in the gas cartridge evaporates so that gaseous fuel is provided again.

The fuels used in grilling, such as liquefied gas, are real gases. When a real gas expands in a confined volume, causing it to evaporate, the evaporated gas cools down so that it can re-liquefy. The temperature of the re-liquefying real gas can reach temperatures below 0° C. and thus below the freezing point of water. This causes water, in particular condensation water, to freeze in the immediate vicinity of the liquefying gas. This re-liquefaction of the real gas due to the temperature drop during evaporation can also be observed during a grilling process when very large quantities of liquefied gas are withdrawn or when larger quantities of liquefied gas are withdrawn over a comparatively long period of time. A layer of ice then forms on the outside of the gas cartridge and on the gas cartridge connection. This layer of ice can, for example, cause the gas cartridge connection to ice up and no longer allow fuel to pass through. In addition, no or too little fuel evaporates at the low fuel or ambient temperatures. The consequence is that the gas grill can no longer be operated.

In particular in winter, when the outside temperature is low, this problem occurs much more frequently than in summer when outside temperatures are high.

In order to avoid involuntary grilling pauses in the event that larger quantities of gas are required in a short time, it is therefore necessary to provide a second gas cartridge or to use a larger cartridge with a larger capacity. However, neither the carrying of an additional cartridge nor the use of a larger and thus heavier cartridge is desirable.

The re-liquefaction of the real gas or the freezing of the gas cylinder, which is due to the Joule Thompson effect, finally also results in the fact that it is difficult to empty a gas cylinder completely.

It is the object of the present invention to provide a gas grill which can be operated at any time with a gas cartridge or gas cylinder adapted to the quantity of gas required, without the risk of icing of the gas cartridge used. In particular, it is the object of the invention to provide a gas grill which also functions reliably in winter with a gas cartridge or gas cylinder adapted to the required amount of fuel and, moreover, always provides a constant output.

According to the invention, the object is achieved by a grilling device comprising a grill housing, a gas-operated heating element and a connecting element which can be connected to a fuel container, wherein the gas-operated heating element is connected to the connecting element by means of a connecting conduit, wherein the connecting conduit has a fuel withdrawal portion adapted to carry fuel in a liquid form and an expansion portion adapted to carry the fuel in a gaseous state, wherein the fuel withdrawal portion is connected to the connecting element upstream in the flow direction of the fuel and opens into the expansion portion downstream in the flow direction.

The connecting conduit as well as the corresponding fuel withdrawal portion or expansion portion are preferably formed as a pipe, for example of metal.

As a result of the fact that the fuel is withdrawn in liquid form from the fuel container, in particular gas container, the risk of the fuel container or the connecting elements connected to the fuel container, such as the connecting element, icing up does not exist or hardly exists anymore. The fuel can thus be completely or almost completely withdrawn from the container. No significant residue remains in the fuel container.

In order to be able to easily remove the fuel in liquid form from the fuel container, it is advantageous to provide a fuel container having a fuel-filled interior space and a fuel container connection, the fuel container connection interacting with the connecting element and being positioned below the interior space. Since the gaseous fuel rises to the top, as long as there is liquid fuel in the container, the fuel in the lower region of the interior space is liquid and can thus be easily withdrawn from the bottom of the container.

Previously known fuel containers, in which the fuel container connection is located at the top of the fuel container, can be mounted, for example, upside down so that the fuel container connection points downwards.

In order to control the amount of fuel withdrawn from the fuel container, it is advantageous that a control valve, in particular a pressure control valve, is provided. For example, the control valve is already provided in or directly on the fuel container connection. Alternatively, the control valve is provided in the flow direction of the fuel at a distance from the fuel container connection in the fuel withdrawal portion.

In order to keep the liquid fuel in the fuel withdrawal portion liquid, it is advantageous that a first nozzle is provided at the end of the fuel withdrawal portion pointing downstream in the flow direction of the fuel. This nozzle ensures that the amount of fuel can be regulated from the fuel withdrawal portion to the expansion portion. In particular, the nozzle is designed such that there is no or only a small pressure drop in the fuel withdrawal portion compared to the pressure in the fuel container, and the expansion of the fuel in the fuel withdrawal portion is thus so small that the fuel remains liquid and thus no icing of the fuel withdrawal portion occurs.

In order to meter the gaseous fuel entering the heating element from the expansion portion as desired, it is advantageous that a second nozzle is provided downstream of the expansion portion in the flow direction of the fuel. The second nozzle can also be used to adjust the pressure drop of the gaseous fuel in the expansion portion.

In this case, it is particularly preferred that a first nozzle is provided at the end of the fuel withdrawal portion pointing downstream in the flow direction of the fuel and a second nozzle is provided downstream of the expansion portion in the flow direction of the fuel, the diameter of the first nozzle being smaller than the diameter of the second nozzle.

In order to prevent the gaseous fuel in the expansion portion from cooling down too much due to its evaporation, which may result in icing of the corresponding pipe portion, it is advantageous that a heating device is provided which heats the expansion portion from the outside at least in portions. In this case, it is of particular advantage that the heating device is the gas-operated heating element. For example, a pipe portion forming the expansion portion may be located in the region of a heating zone of the heating element present in the grilling device.

In order to provide the required quantity of gas or a required air/gas mixture to the heating elements as desired, it is advantageous that the expansion portion opens downstream in the flow direction of the fuel into a pipe portion for treating a gas/air mixture. Preferably, the pipe portion for treating a gas/air mixture comprises an opening for the supply of oxygen or air.

In a preferred further embodiment, the pipe portion for treating a gas/air mixture is a manifold so that more than one heating element can be supplied by means of a single gas cartridge.

Preferably, a fuel container is provided on the connecting element, which fuel container contains liquefied gas such as propane, butane, and isobutane or a mixture of at least two of the fuels propane, butane, and isobutane.

The subject of the present invention also includes a method for operating a grilling device having a grill housing, a gas-operated heating element, and a connecting element connected to a fuel container, wherein the gas-operated heating element is connected to the connecting element by means of a connecting conduit, wherein the fuel is withdrawn from the fuel container in a liquid state, the fuel withdrawn from the fuel container in a liquid state is passed through a fuel withdrawal portion of the connecting conduit to an expansion portion of the connecting conduit, the liquid fuel becomes gaseous in the expansion portion, and the gaseous fuel is supplied to the heating element.

Preferably, the fuel in the expansion portion is heated from the outside, and in a preferred further embodiment, the heat comes from the heating element contained in the grilling device.

In order to generate the suitable combustion gas, it is further provided that air, in particular oxygen, is supplied to the fuel downstream of the expansion portion but upstream of the gas-operated heating element in the flow direction of the fuel.

Preferred embodiments will be explained in more detail with reference to the accompanying drawings, in which:

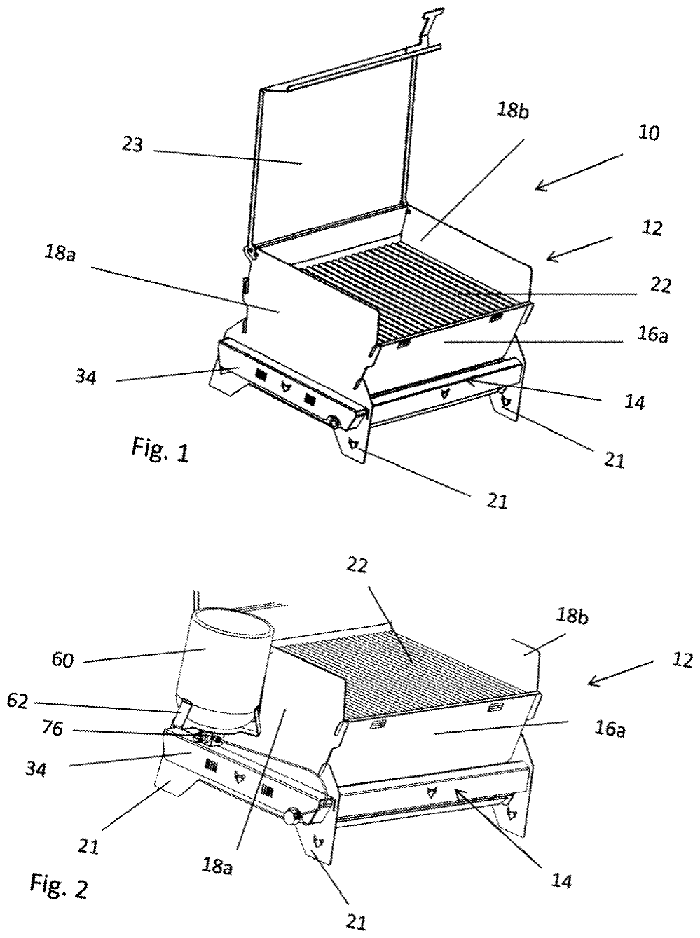

FIG. 1 is a perspective view of a grill;

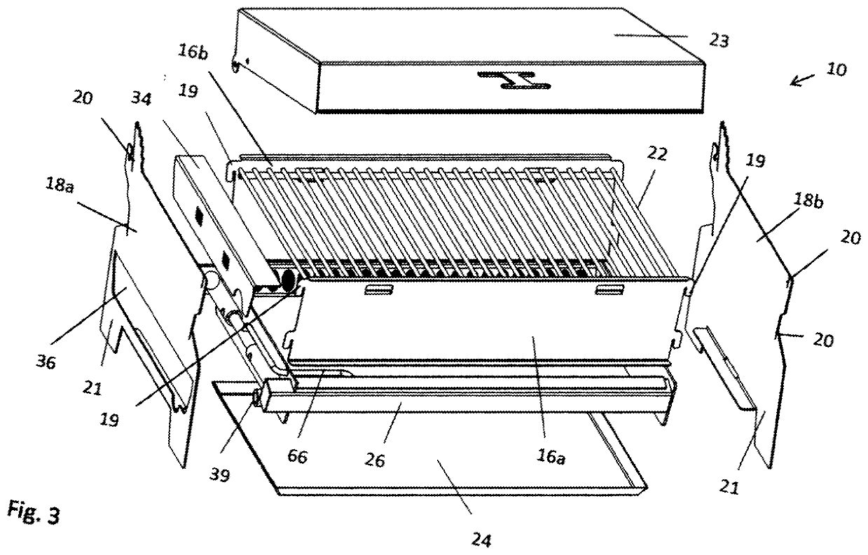

FIG. 2 shows the grill shown in FIG. 1 with a fuel container;

FIG. 3 is a partially disassembled view of the grill shown in FIG. 1;

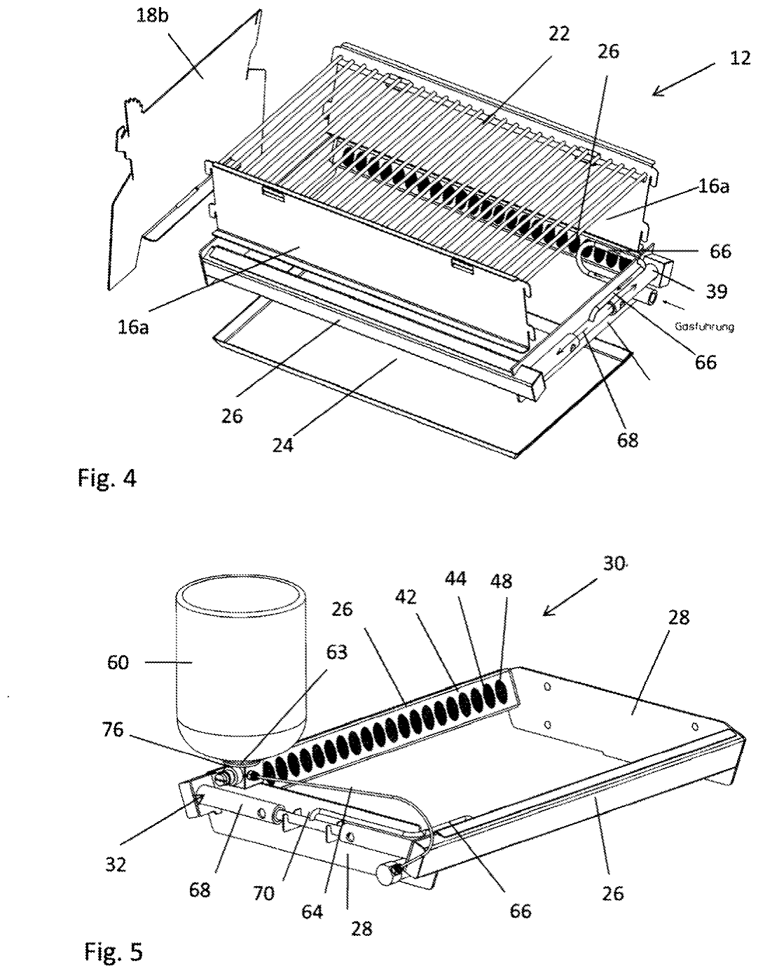

FIG. 4 is a partially disassembled view of a part of the gas grill shown in FIG. 1;

FIG. 5 is a perspective view of the base element of the grill with the fuel container shown in FIG. 2;

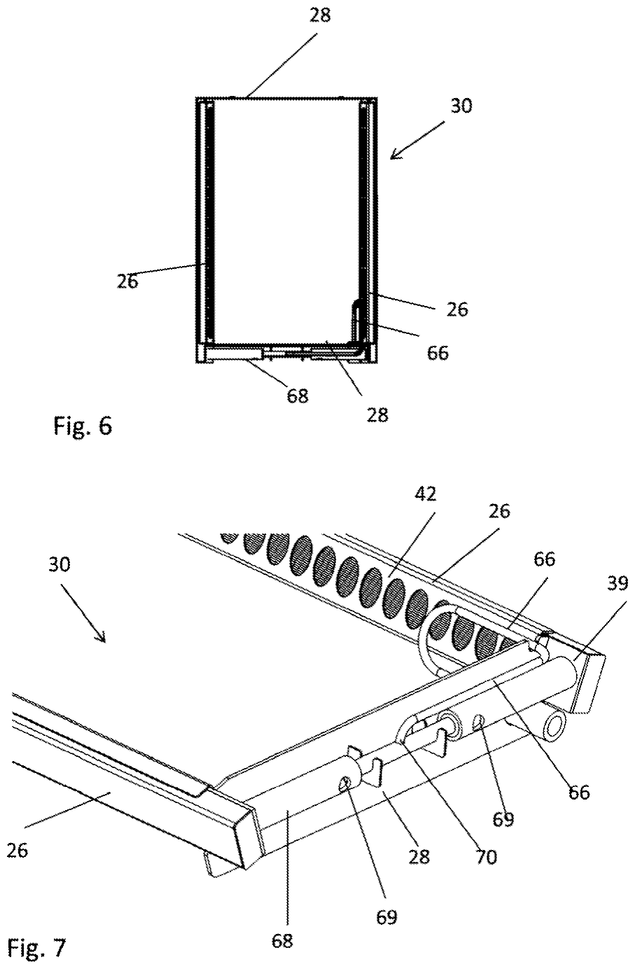

FIG. 6 is a plan view of the base element;

FIG. 7 is a perspective view of a part of the base element of the grill shown in FIG. 1;

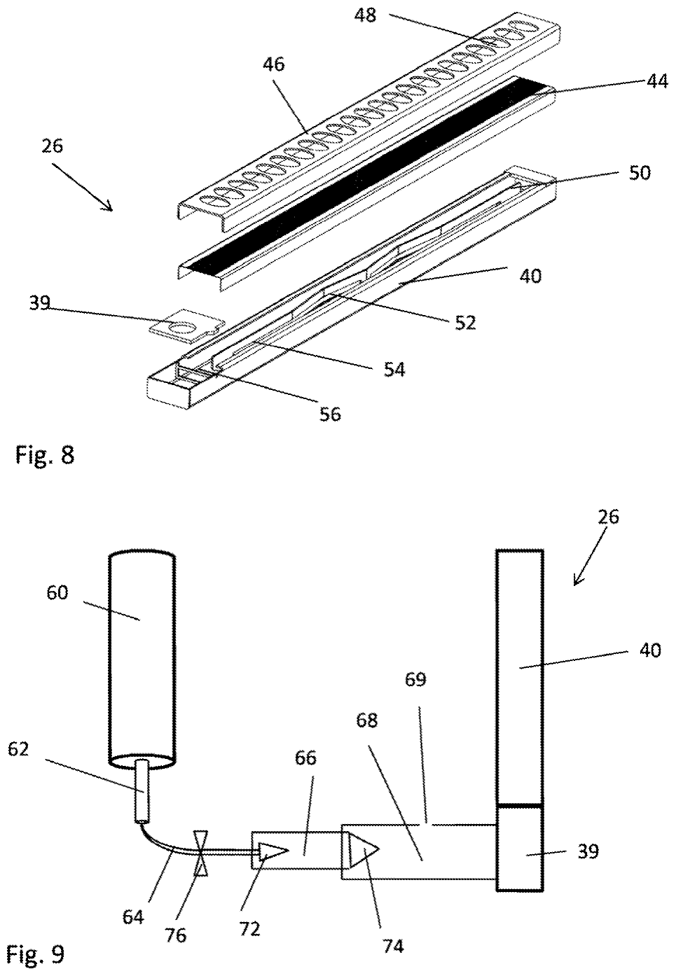

FIG. 8 is an exploded view of the heating element; and

FIG. 9 is a schematic representation of the gas connection conduit together with a fuel container and a heating element.

FIGS. 1 and 3 show a gas operable grilling device 10.

The grilling device 10 comprises a grill housing 12 having a base element 14. Furthermore, as can be seen in particular in FIG. 3, a first side part 16a, a second side part 16b, and two transverse parts 18a and 18b are provided. The two side parts 16a, 16b and the two transverse parts 18a, 18b form the side walls of the grill housing 12 and thus an interior space open at the top and bottom.

The side parts 16a and 16b and the transverse parts 18a, 18b are substantially plate-like in shape. Connecting elements in the form of hooks 19 and slots 20 are provided on the side parts 16a and 16b and on the transverse parts 18a and 18b for releasably connecting the side parts 16a, 16b and the transverse parts 18a, 18b to one another. When the side parts 16a, 16b and the transverse parts 18a, 18b are connected to one another as intended, the grill housing 12 has a square, in particular rectangular, basic shape in cross section. Here, the side parts 16a and 16b form the longitudinal side of the grill housing 12, while the transverse part 18a forms the front end face and the other transverse part 18b forms the rear end face of the grill housing 12.

The transverse parts 18a, 18b each have two extensions 21 extending downwardly, the two extensions 21 each being provided on two opposite sides of the transverse part 18, 18b and forming the feet for supporting the grilling device 10. While the transverse parts 18 are oriented vertically or perpendicularly, the first side part 16a and the second side part 16b are inclined so that the grill housing 12 expands upwardly along its longitudinal sides.

The first side part 16a, the second side part 16b, and the two transverse parts 18a, 18b are made of metal.

A grill food support 22 is located on the open top side of the grill housing 12. Furthermore, a cover 23 is provided to close the top of the housing 12. In this case, the cover 23 is pivotally connected to the housing 12, in particular to the two transverse parts 18a, 18b.

The base element 14 forms the underside of the grill housing 12 and includes a base tray 24, as well as two heating elements 26 and two transverse struts 28. As can be seen in particular in FIG. 5, the heating elements 26 and the transverse struts are fixedly connected to one another and form a frame 30 in which the two heating elements 26 are arranged opposite to one another (see also FIG. 6). On the underside of the frame is the base tray 24, which is detachably connected to the frame, in particular is inserted therein in order to clean the base tray 24, for example after use. When inserted, the base tray 24 forms the base of the base element 14.

Although not shown, the base element may also comprise a frame formed of transverse and longitudinal struts, the heating elements being fastened to the longitudinal or transverse struts.

The frame 30 is arranged below the side parts 16a and 16b, with the two heating elements 26 each extending below the two side parts 16a and 16b along the longitudinal side of the grill housing 12. A part of a connecting conduit 32 for supplying fuel to the heating element 26 is provided on the outside of the transverse strut 28, which is located on the front end face of the housing 12.

When the grilling device is assembled, the connecting conduits 32 arranged on the transverse struts 28 are covered by a cover 34.

An opening 36 is provided in the transverse part 18a at the front end of the housing 12, through which opening the cover 34 protrudes.

The heating element 26 is in the form of a heating rod and includes a gas supply 39 and a combustion chamber 40 open at the top and having a top surface 42. The thermal radiation of the heating rod 26 is emitted via the top surface 42. The heating rod 26 is rotated about its longitudinal axis such that the top surface 42 points obliquely upwardly toward each of the opposing side parts 16a, 16b. Furthermore, the heating rod 26 is offset outwardly relative to the corresponding side part 16a, 16b to recess the top surface 42 of the heating rod 26 inside the grill housing 12 relative to the corresponding side part 16a, 16b. This prevents grease, etc. from dripping onto the burner, which can cause an unpleasant grease fire.

In an embodiment of a grilling device (not shown), the heating rod may also be oriented such that the top surface of the heating rod points to the opposite side part, thereby emitting thermal radiation substantially horizontally.

The heating rod 26 can heat the ambient air as well as emit infrared radiation.

The heat emitted from the heating rod 26 due to thermal and infrared radiation rises upwardly toward the grill food support 22. Furthermore, the thermal radiation and/or the infrared radiation emitted by the heating rod 26 is reflected at the respective opposite side part 16a, 16b and guided towards the grill food support 22.

FIG. 8 shows a preferred embodiment of a heating rod 26.

As can be seen in FIG. 8, the gas supply 39 opens into the open side of the combustion chamber. Outside the gas supply 39, the combustion chamber 40, which is open at the top, is completely covered by a multilayer metal mesh 44, in particular stainless steel mesh. A ledge 46 having a plurality of openings 48 is located on the metal mesh 44. Said ledge 46 forms the cover of the combustion chamber 40. Inside the combustion chamber 40, a gas guiding means is arranged in the form of a partition 50 extending along the longitudinal axis of the combustion chamber 40. The partition 50 is bent a number of times in the central portion 52 relative to the longitudinal axis, so that the partition 50 has a zigzag shape in the central portion when viewed from above. A plurality of longitudinal slots 54 are provided in the partition 50 itself. Furthermore, a second gas guiding means in the form of a screen 56 is provided, which reduces the diameter of the combustion chamber 40. This screen 56 is optional. In an embodiment (not shown), this screen is omitted.

Each heating element 26 is supplied with gaseous fuel by means of the gas supply 39. For this purpose, as shown in FIG. 5, a connecting conduit 32 is provided which is connected at one end to a fuel container 60 arranged outside the grilling device and at the opposite end opens into the gas supply 39 of the heating element 26.

In particular, as can be seen in FIG. 5, a fuel container holder 62 is provided on the outside of the housing 12. A connecting element (not shown) is included in the fuel container holder 62. The fuel container 60 has an interior space in which fuel is located and a fuel container connection 63, only a small portion of which is shown in FIG. 5. The fuel container 60 is removably fastened in the fuel container holder 62 by means of the fuel container connection 63. The fuel container holder 62 is mounted such that the fuel container 60 is held upside down, and thus the fuel container connection 63 is located below the interior space. This arrangement ensures that the fuel withdrawn from the fuel container 60 is liquid as long as there is liquid fuel in the fuel container 60.

As can also be seen in FIG. 5, the connecting conduit 32 connecting the fuel container 60 to the heating elements 26 comprises three portions, namely a fuel withdrawal portion 64, an expansion portion 66, and a pipe portion formed as a manifold 68 for treating a gas/air mixture

The connecting conduit is formed of metal pipes, in particular stainless steel pipes of different diameters.

A small diameter pipe portion extends from the fuel container holder 62 to a larger diameter pipe portion. The pipe portion having the smaller diameter forms the fuel withdrawal portion 64. The larger diameter pipe portion that connects to the fuel withdrawal portion 64 is the expansion portion 66 of the connecting conduit 32. The interface between the fuel withdrawal portion 64 and the expansion portion 66 is provided in the vicinity of a heating element 26 in the region of the front end of the heating element. As can be seen in FIG. 7, the expansion portion 66 of the connecting conduit 32 loops along the top surface 42 of the heating rod 26 at a short distance from the heating rod 26 and opens into the manifold 68 which extends along a transverse strut 28 of the frame 30. The pipe section of the manifold 68 again has a larger diameter than the pipe section of the expansion portion 66. Openings 69 are provided in the manifold 68 for mixing the gaseous fuel contained in the manifold 68 with air. The manifold 68 has a branch 70 to guide the gaseous fuel in the connecting conduits 32 to the two heating rods 26.

As can be better seen in FIG. 9, a first nozzle 72 is provided between the fuel withdrawal portion 64 and the expansion portion 66 to guide the liquid fuel into the expansion portion 66. In the flow direction of the fuel, a second nozzle 74 is arranged downstream of the expansion portion 66 to allow the fuel to flow into the manifold 68. Furthermore, a valve 76, in particular a pressure control valve, is provided to keep the pressure in the fuel withdrawal portion 64 as constant as possible. The valve 76 may already be integral with the fuel container connection 63, or may be formed as a separate component downstream of the gas container connection 63 in the fuel withdrawal portion 64 or in the fuel container holder 62.

As indicated above, the diameter of the pipe in the fuel withdrawal portion 64 is smaller than the diameter of the pipe in the expansion portion 66, and the diameter of the manifold 68 is in turn greater than the diameter of the pipe in the expansion portion 66. The choice of the diameter of the pipe in the fuel withdrawal portion 64 depends, for example, on the gas pressure in the fuel container 60. The ratio of the diameters of the pipes between the expansion portion 66 and the fuel withdrawal portion 64 depends, among other things, on the quantity of gas required at the heating rods 26 and/or the pressure in the fuel container 60.

The diameter of the first nozzle 72 is smaller than the diameter of the second nozzle 74. Here, the ratio of the diameters of the first nozzle 72 to the second nozzle 74 may be, for example, between 1:1.25 up to 1:2.

The fuel used is a liquefied gas such as propane, butane, or isobutane, or preferably a mixture of the gases propane, butane, and isobutane.

In the arrangement described, the fuel is withdrawn from the fuel container 60 in the liquid state, enters the fuel withdrawal portion 64 in the liquid state, and from there the fuel is fed into the expansion portion 66 in which the fuel is allowed to expand and thus become gaseous. The gaseous fuel is mixed with air in the manifold 68 and then enters the heating rods 26.

In order to keep the pressure in the fuel withdrawal portion 64 constant and thus keep the fuel liquid, both the pressure control valve 76 and the first nozzle 72 are provided.

In the expansion portion 66, there is a risk that the energy required for evaporating the fuel is so great that the fuel liquefies again or parts of the conduit freeze. To prevent re-liquefaction of the fuel or freezing of the pipe during evaporation of the fuel, the heat required for expansion of the fuel is provided by passing the expansion portion 66 along the heating element 26. More specifically, the pipe forming the expansion portion 66 is looped at a distance from the heating element 26.

In the embodiment shown, the heat required in the expansion portion 66 is provided by the heating rod 26. In an embodiment (not shown), the heat supplied in the expansion portion 66 is supplied from an external heat source.

It is understood that in the context of the invention the manifold may have more than one branch to supply gas, i.e. gaseous fuel, to more than two gas-operated heating elements. Alternatively, instead of the manifold, a simple pipe portion may be provided for treating an air/gas mixture to supply gaseous fuel to only one heating element.

Instead of the grilling device 10 shown in the description, any gas-operated grilling device may be used in conjunction with the gas supply shown, which includes a fuel container and connecting conduits from the fuel container to the heating element.

For example, alternative grilling devices may provide only one heating rod or may provide a plurality of heating rods. It is not essential to use a heating element in an elongated shape such as a heating rod. In connection with the invention, gas-operated heating elements can also be used which have a different geometry, for example which are round in shape.

A plurality of openings are provided in the heating element shown. In an alternative embodiment (not shown), the heating element comprises only one opening.

The arrangement of the heating elements in the grilling device as well as the design of the grill housing are also independent of the gas supply.

A ceramic heating device can also be used instead of the heating element described.

In the context of the invention, it is not essential that the heating element emit infrared radiation.

Regardless of the type of gas-operated grilling device selected, the advantage of the present gas supply is that a comparatively large quantity of gas can be provided in a short time, so that more than one heating element can be reliably supplied with fuel even at low outside temperatures.

It is to be understood that embodiments in which individual features of the embodiments shown have been omitted or combined in a different form are also encompassed within the context of the invention.

1. A grilling device comprising a grill housing (10), a gas-operated heating element (26), and a connecting element which can be connected to a fuel container (60), wherein the gas-operated heating element (26) is connected to the connecting element by means of a connecting conduit (32), characterized in that the connecting conduit (32) has a fuel withdrawal portion (64) adapted to carry fuel in a liquid form and an expansion portion (66) adapted to carry the fuel in a gaseous state, wherein the fuel withdrawal portion (64) is connected to the connecting element upstream in the flow direction of the fuel and opens into the expansion portion (66) downstream in the flow direction.

2. The grilling device according to claim 1, characterized in that a fuel container (60) having a fuel-filled interior space and a fuel container connection (63) is provided, the fuel container connection (63) interacting with the connecting element and being positioned below the interior space.

3. The grilling device according to claim 1, characterized in that a control valve (76), in particular a pressure control valve, is provided.

4. The grilling device according to claim 1, characterized in that a first nozzle (72) is provided at the end of the fuel withdrawal portion (64) pointing downstream in the flow direction of the fuel and/or a second nozzle (74) is provided downstream of the expansion portion (66) in the flow direction of the fuel.

5. The grilling device according to claim 1, characterized in that a first nozzle (72) is provided at the end of the fuel a withdrawal portion (64) pointing downstream in the flow direction of the fuel, and a second nozzle (74) is provided downstream of the expansion portion (66) in the flow direction of the fuel, the diameter of the first nozzle (72) being smaller than the diameter of the second nozzle (74).

6. The grilling device according to claim 1, characterized in that a heating device is provided which heats the expansion portion (66) at least in portions from the outside.

7. The grilling device according to claim 6, characterized in that the heating device is the gas operated heating element (26).

8. The grilling device according to claim 1, characterized in that the expansion portion (66) opens dowsntream, in the flow direction of the fuel, into a pipe portion for treating an air/gas mixture.

9. The grilling device according to claim 8, characterized in that the pipe portion for treating an air/gas mixture is a manifold (68).

10. The grilling device according to claim 1, characterized in that a fuel container (60) is provided on the connecting element, which fuel container contains liquefied gas, in particular propane, butane, and isobutane or a mixture of at least two of the fuels propane, butane, and isobutane.

11. A method for operating a grilling device comprising a grill housing, a gas-operated heating element (26), and a connecting element connected to a fuel container (60), wherein the gas-operated heating element (26) is connected to the connecting element by means of a connecting conduit (32), characterized in that
the fuel is withdrawn from the fuel container (60) in a liquid state,
the fuel withdrawn from the fuel container (60) is passed in a liquid state through a fuel withdrawal portion (64) of the connecting conduit (32) to an expansion portion (66) of the connecting conduit (32), the liquid fuel in the expansion portion (66) becoming gaseous, and
the gaseous fuel is supplied to the heating element (26).

12. The method according to claim 11, characterized in that the fuel in the expansion portion (66) heated from the outside.

13. The method according to claim 11, characterized in that air, in particular oxygen, is supplied to the fuel downstream of the expansion portion (66) but upstream of the gas-operated heating element (26) in the flow direction of the fuel.
